(19) United States
(12) Patent Application Publication
(10) Pub. No.: US 2006/0102719 A1
(43) Pub. Date: May 18, 2006

(54) Voting machine with a hinge mechanism

(76) Inventor: Tse-Hua Hsueh, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/986,766

(22) Filed: Nov. 15, 2004

(51) Int. Cl. G07C 13/00

(52) U.S. Cl. 235/386

(57) ABSTRACT

A voting machine with a hinge mechanism includes a body, a display electrically connecting with the body, and a hinge mechanism connected between the body and the display. The hinge mechanism includes a pair of hinge boards, a pair of positioning seats and a pair of support levers. The hinge boards are rotatably connected to the display. The positioning seats are connected to opposite sides of the body with a plurality of recesses being defined therein. One end of the support lever is pivotally connected to the display and the other end of the support lever is connected with a positioning post. The positioning post is receivable in each of the recesses of the positioning seat.

### BACKGROUND OF THE INVENTION

1. Field of the Invention

The present invention relates to a voting machine, and particularly to a voting machine with a hinge mechanism for convenience of use.

2. Prior Art

Elections are widely hold for different purposes. A voting paper is used to record an opinion of a voter in a conventional selection. Then the election result is provided through manually counting each opinion of the voting papers. However, when a great quantity of people attend an election, such as a government election, it is complicated to manually count the voting papers. The manual counting even readily causes a wrong voting result. To encounter the above problems, a voting machine is provided to record and automatically count the voting papers and then provide a precise voting result. A conventional voting machine includes a housing and a screen integrally and upwards extending from the housing. However, the voting machine occupies quite large space due to the upwards extending screen. It is inconvenient to store or transport the voting machine since it occupies large space. Furthermore, since the screen is integral with the housing, the position of the screen cannot be adjusted according to tables with different height. So, the voting machine is inconvenient in use.

Therefore, it is required to improve the conventional voting machine.

### SUMMARY OF THE INVENTION

Accordingly, an object of the present invention is to provide a voting machine with a hinge mechanism connected between a display and a body for rotating the display to be closed to the body thereby reducing occupying space of the display for convenience of storage or transportation of the voting machine.

Another object of the present invention is to provide a voting machine with a hinge mechanism connected between a display and a body for rotating the display to adjust the position thereof relative to the body thereby facilitating to use the voting machine.

Further object of the present invention is to provide a voting machine with a hinge mechanism connected between a display and a body for rotating the display about the hinge mechanism and having a hood for preventing the display from undesirably rotating about the hinge mechanism.

To achieve the above-mentioned objects, a voting machine with a hinge mechanism in accordance with the present invention includes a body, a display electrically connecting with the body, and a hinge mechanism connected between the body and the display. The hinge mechanism includes a pair of hinge boards, a pair of positioning seats and a pair of support levers. The hinge boards are connected to the display and the body. The positioning seats are connected to opposite sides of the body with a plurality of recesses being defined therein. One end of the support lever is pivotally connected to the display and the other end of the support lever is connected with a positioning post. The positioning post is receivable in each of the recesses of the positioning seat.

Other objects, advantages and novel features of the present invention will be drawn from the following detailed embodiments of the present invention with attached drawings, in which:

### BRIEF DESCRIPTION OF THE DRAWINGS

FIG. 1 is a perspective view of a voting machine with a hinge mechanism of the present invention showing a display being in a closed position;

FIG. 2 is similar to FIG. 1 but showing the display being in an opened position;

FIG. 3 is an exploded view of FIG. 2;

FIG. 4 is a side elevational view of FIG. 1;

FIG. 5 is a cross-sectional view taken in FIG. 4; and

FIG. 6 is a side elevational view showing the display being rotated to adjust the position thereof.

### DESCRIPTION OF THE PREFERRED EMBODIMENT

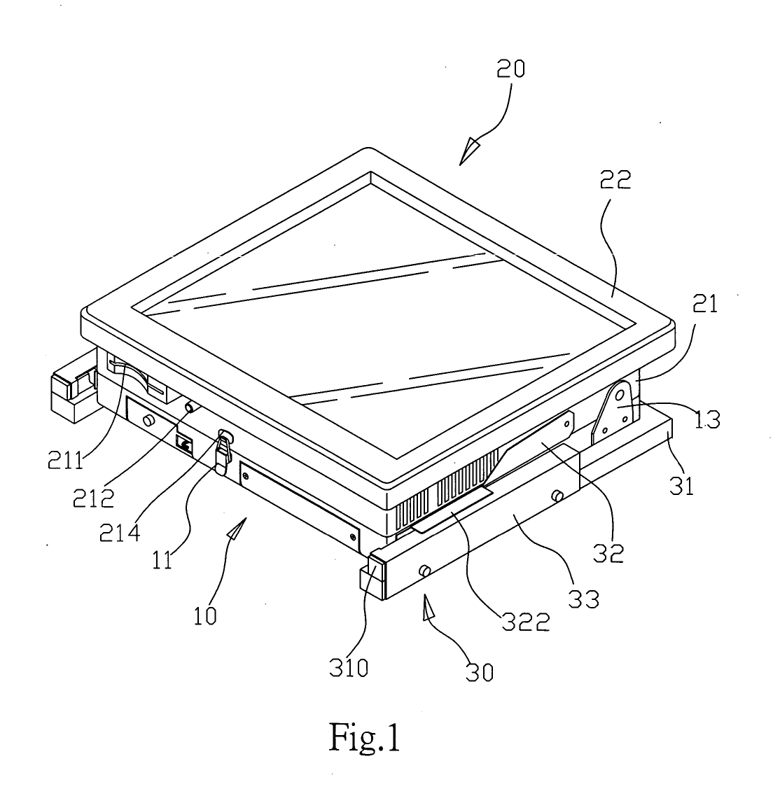

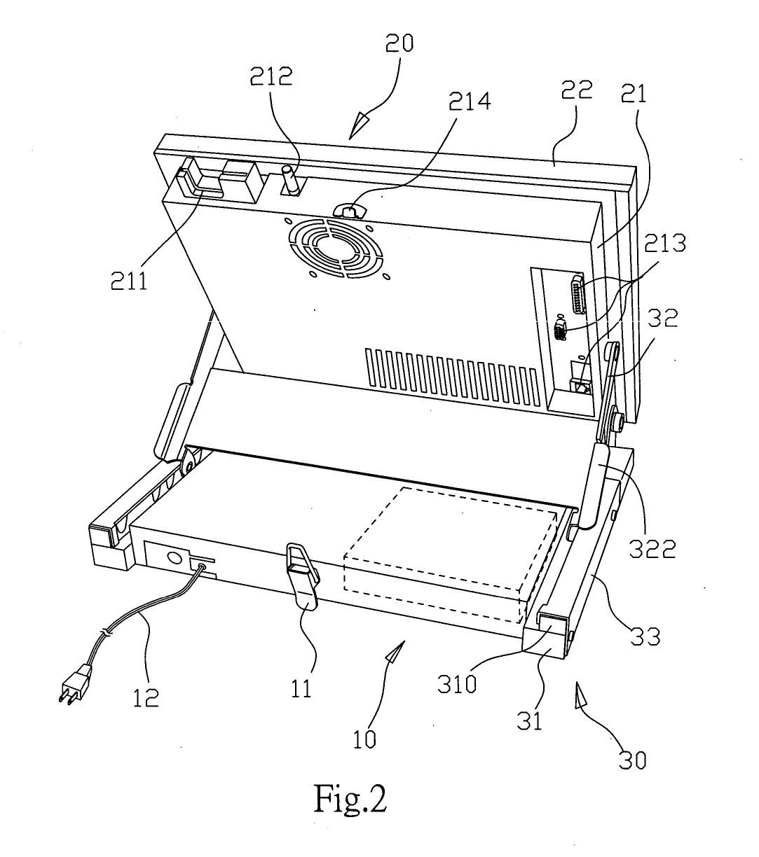

Referring to FIGS. 1-3, a voting machine with a hinge mechanism of the present invention includes a body 10, a display 20 electrically connecting with the body 10, and a hinge mechanism 30. A clip 11 and a power line 12 are respectively disposed at the rear of the body 10. The display 20 includes a housing 21 and a screen 22. A card connector 211 and a wireless transmission antenna 212 are respectively disposed at the top of the housing 21. The card connector 211 is receivable an identity card for verifying the identity of a voter and reading voting information. The antenna 212 is for wireless connection to Internet or for wireless data transmission. A plurality of electrical connectors 213 is disposed at the housing 21 for connecting with corresponding peripherals. A protrusion 214 extends from the housing 21 corresponding to the clip 11 of the body 10. In closing the display 20 to the body 10, the clip 11 of body 10 is engaged with the protrusion 214 thereby fixing the display 20 to the body 10.

The hinge mechanism 30 is connected between the body 10 and the display 20 and includes a pair of hinge boards 13 disposed at the front of the body 10. One end of each hinge board 13 is pivotally connected to the housing 21. Therefore the display 20 is pivoted about the hinge boards 13 and closed to the body 10 whereby the display 20 can be opened at an opened position for use and can be closed at a closed position to reduce occupying space thereof for convenience of storage or transportation.

The hinge mechanism 30 further includes a pair of positioning seats 31, a pair of support levers 32 and a pair of hoods 33. The positioning seats 31 are respectively fixed to the opposite sides of body 10 each with a lock portion 310 being formed thereon. A plurality of recesses 311 is defined in each lock portion 310, each with an arcuate edge 312 being formed at the bottom thereof. Two screw holes 313 are defined in the outer side of each positioning seat 31. One end of the support lever 32 is pivotally connected the housing 21 of the display 20. The other end of the support lever 32 is rotatably connected with a positioning post, which is cylindrical for being readily received in one of recesses 311. A board-shaped handle 322 extends from a side edge of the support lever 32 adjacent to the positioning post 321 for facilitating to move the support lever 32. The hood 33 is generally L-shaped and includes a sidewall 331 and an upper wall 332 perpendicularly extending from the sidewall 331. Two positioning holes 333 are defined in the sidewall 331 corresponding to the screw holes 313 of the positioning seat 31. Two tabs 334 extend from opposite ends of the upper wall 332 opposite the sidewall 331. In assembly, the hood 33 covers on the positioning seat 31 with the tabs 334 abutting the inner side of the lock portion 310. Two bolts 335 extend through the positioning hole 333 of the hood 30 and then engage with the screw holes 313 of the positioning seat 31 respectively.

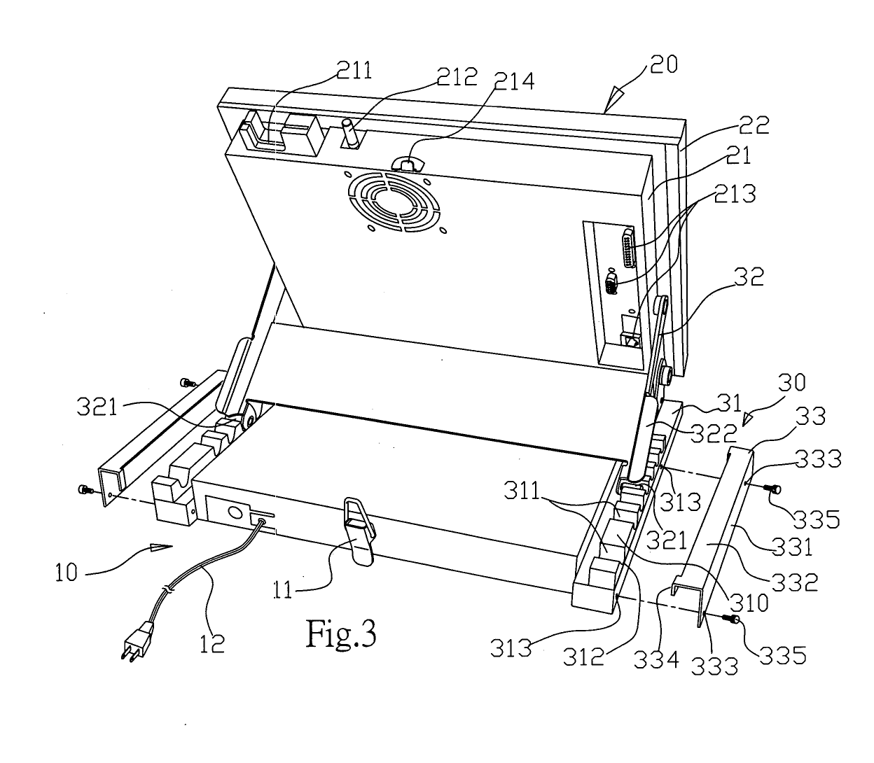

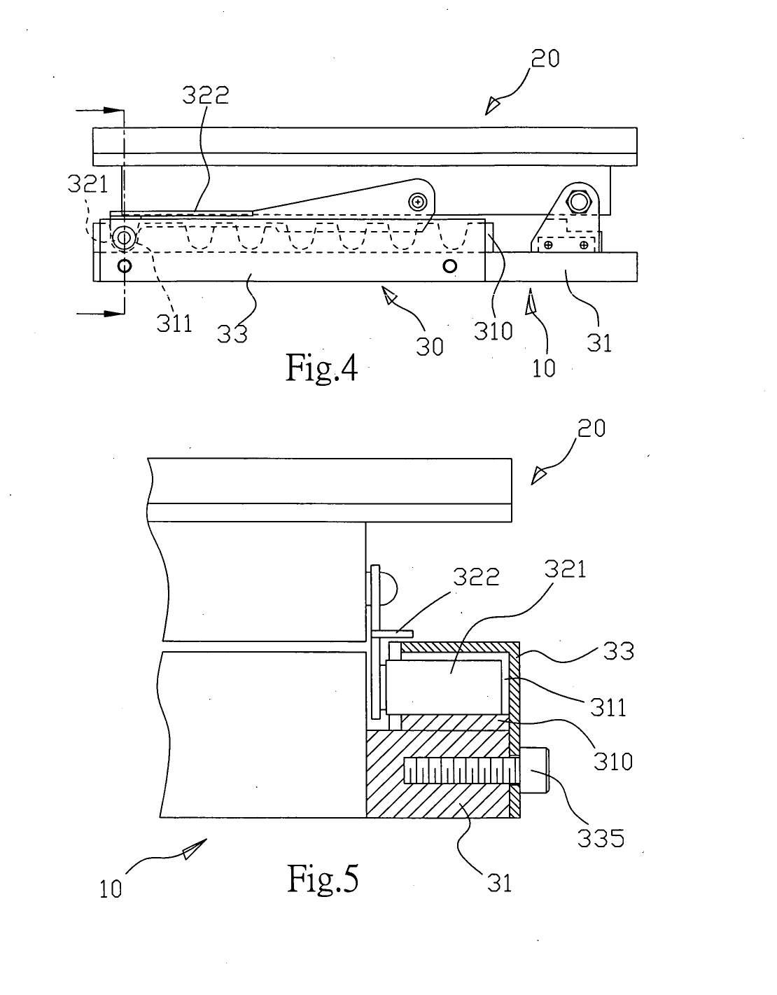

Referring to FIGS. 3-5, in closing the display 20 to the body 10, each hood 33 is detached from the positioning seat 31 through unscrewing the bolts 335 thereby exposing the recesses 311 of the lock portion 310. Each positioning post 321 of the support lever 32 is moved to the furthest recess 311 of the lock portion 310 relative to the hinge board 13 through the handle 322 of the support lever 32. The display 20 is pivoted about the hinge board 13 and closed to the body 10 at the closed position thereby reducing the occupying space thereof. Finally the hood 33 is attached to the positioning seat 31 through the bolts 335. Thus, the voting machine is ready to close through the hinge mechanism 30 for reducing the occupying space thereof thereby facilitating to store or transport.

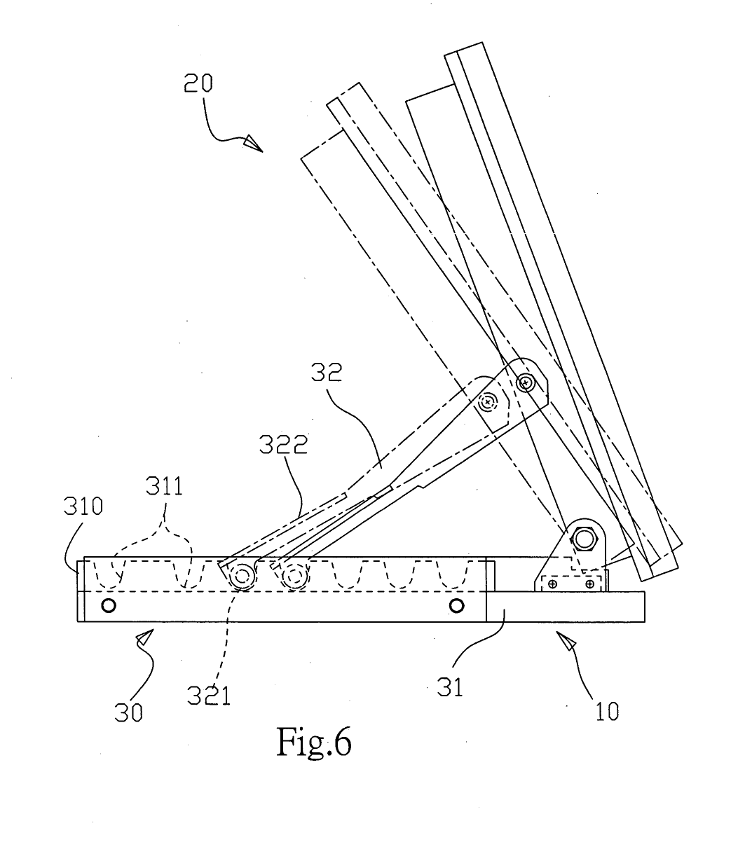

In adjusting the position of the display 20 during use, each hood 33 is detached from the lock portion 310. Each positioning post 321 is moved to a suitable recess 311 (see FIG. 6) of the lock portion 310 for rotating the display 20 about the hinge board 13 through the handle 322 of the support lever 32. Finally the hood 33 is attached to the positioning seat 31. Thus, the position of the display 20 is adjustable for convenient use.

Furthermore, each hood 33 covers all of the recesses 311 of the lock portion 310 and the positioning post 321 of the support lever 32 thereby preventing the display 20 from undesirably rotating about the hinge board 13.

It is understood that the invention may be embodied in other forms without departing from the spirit thereof. Thus, the present examples and embodiments are to be considered in all respects as illustrative and not restrictive, and the invention is not to be limited to the details given herein.

1. A voting machine with a hinge mechanism, comprising:
a body;
a display electrically connecting with the body; and
a hinge mechanism connected between the body and the display, the hinge mechanism comprising a pair of hinge boards, a pair of positioning seats and a pair of support levers, the hinge boards being connected to the body and the display, the positioning seats being connected to opposite sides of the body with a plurality of recesses being defined therein, one end of the support lever being pivotally connected to the display and the other end of the support lever being connected with a positioning post, the positioning post being receivable in each of the recesses of the positioning seat.

2. The voting machine with a hinge mechanism as claimed in claim 1, wherein a clip is disposed at the rear of the body, and a protrusion is formed at the display corresponding to the clip.

3. The voting machine with a hinge mechanism as claimed in claim 1, wherein the display includes a housing and a screen, and a card connector and a wireless transmission antenna are disposed at the top of the housing.

4. The voting machine with a hinge mechanism as claimed in claim 1, wherein a plurality of electrical connectors is disposed at the housing for connecting with corresponding peripherals.

5. The voting machine with a hinge mechanism as claimed in claim 3, wherein the hinge boards are fixed at the front of the body, and the hinge boards are pivotally connected to the housing, whereby the display is rotatable about the hinge boards for being closed to or opened from the body.

6. The voting machine with a hinge mechanism as claimed in claim 1, wherein each positioning seat includes a lock portion, the plurality of recesses is defined in the lock portion.

7. The voting machine with a hinge mechanism as claimed in claim 1, wherein an arcuate edge is formed at the bottom of each recess.

8. The voting machine with a hinge mechanism as claimed in claim 1, wherein a plurality of screw holes is defined in each positioning seat.

9. The voting machine with a hinge mechanism as claimed in claim 1, wherein each positioning post is rotatably connected to the support lever.

10. The voting machine with a hinge mechanism as claimed in claim 1, wherein a handle extends from a side of each support lever.

11. The voting machine with a hinge mechanism as claimed in claim 8, wherein the hinge mechanism further comprises a pair of hoods respectively covering on the positioning seat.

12. The voting machine with a hinge mechanism as claimed in claim 11, wherein each hood is generally L-shaped and includes a sidewall and an upper wall extending from the sidewall, and a plurality of positioning holes is defined in each sidewall corresponding to the screw holes of the positioning seat.

13. The voting machine with a hinge mechanism as claimed in claim 12, wherein a plurality of tabs extends from the upper wall of each hood opposite the sidewall.
